(19) United States
(12) Patent Application Publication
(10) Pub. No.: US 2026/0101986 A1
(43) Pub. Date: Apr. 16, 2026

(54) Intelligent Lighted Cosmetic Box

(71) Applicant: Rikun LI, Zhuhai (CN)

(72) Inventor: Rikun LI, Zhuhai (CN)

(21) Appl. No.: 18/936,777

(22) Filed: Nov. 4, 2024

(30) Foreign Application Priority Data
Oct. 15, 2024 (CN) 2024224921638

(51) Int. Cl. A45D 33/00; F21S 4/00; F21S 9/02; F21Y 107/20

(52) U.S. Cl. CPC A45D 33/008; F21S 4/00; F21S 9/02; F21Y 2107/20

(57) ABSTRACT

This invention belongs to the technical field of cosmetic boxes, especially to intelligent lighted cosmetic box, which includes a top cover and a bottom cover. The top cover is hinged with the bottom cover, and a magnetic suction mechanism is provided at the connection of one side of the top cover and the bottom cover. The inner cavity of the top cover is fixedly connected with a lighting component through bolts, and a fixing groove is opened at one end of the top cover with the fixing groove being concave downward. By using batteries, circuit boards, and USB power interface, the light strip inside the cosmetic box can be recharged and powered, providing bright light intelligently. Light-shielding plate can soften the light emitted from the light strip, allowing users to have a clearer view while applying makeup without being obstructed, greatly enhancing the user experience and meeting the needs.

### TECHNICAL FIELD

This invention belongs to the field of cosmetic box technology, specifically involving intelligent lighted cosmetic box.

### Background of the Present Invention

Cosmetic box is a small portable box used to hold products, typically for touch-ups on the go. They typically have hinged or clasp lids, and include applicators and mirrors for applying bronzer, powder, eyeshadow, and blush.

In existing cosmetic boxes, the lights usually need to be manually turned on or off, which is not very convenient to use. At the same time, some cosmetic boxes do not consider the issue of obstructed vision that users may encounter during makeup application, which could affect the user experience. Therefore, the design of intelligent lighted cosmetic box aims to solve these problems.

### Summary of Present Invention

To address the shortcomings of existing technologies, this invention provides intelligent light-up cosmetic box. In order to achieve the goal of intelligent lighting, it solves the problems of inconvenience and lack of consideration for possible visual obstructions during makeup application in existing cosmetic boxes, which may affect the user experience.

To achieve the above objectives, the invention provides the following technical solution: intelligent lighted cosmetic box, comprising a top cover and a bottom cover, wherein the top cover is hinged and connected to the bottom cover, a magnetic adsorption mechanism is provided at the connection of one side of the top cover and the bottom cover, and the inner cavity of the top cover is fixedly connected with a lighting component through bolts;

Lighting component comprising a mounting plate, a light strip, a light shield, screws, batteries, a circuit board, integrated circuit chips, and a power interface. The inner cavity of the upper cover is fixedly connected with mounting plates on both sides. The outer side of the mounting plate is embedded with a light strip, and a light shield is set below the light strip. Screws are slidably installed at the four corners of the light shield, and a battery is installed on the top of the light shield. The output end of the battery is connected to the circuit board, and one side of the circuit board is fixedly connected to integrated circuit chips at the top. One end of the integrated circuit chip is connected to a power interface, which is located at the hinge between the upper cover and the bottom cover.

Furthermore, the lighting component also includes a middle frame, a mirror, and a light-transmitting plate. The inner wall at the connection of the upper cover and the lower cover is provided with a middle frame. The middle frame is of a symmetrical detachable structure and is fixed to the light-shielding plate by bolts. Light-transmitting plates are opened on both sides of the surface of the light-shielding plate, and a mirror is embedded in one side of the middle frame.

Furthermore, the magnetic suction mechanism includes a connecting block, a magnet, and an iron piece. One end of the peripheral side of the upper cover is fixedly connected to the connecting block by a bolt. The two ends of the connecting block are fixedly connected to the magnet. One side of the magnet facing each other is provided with an iron piece, which is fixedly connected to the bottom cover.

Furthermore, the iron pieces are arranged in four, symmetrically distributed at one end of the middle frame, and the iron pieces are distributed in a groove-like manner.

Furthermore, a tray is installed on the top of one side of the middle frame, and the interior of the tray matches the mirror.

Furthermore, one end of the upper cover is provided with a fixed groove, and the fixed groove is concave downward.

The beneficial effect of this invention compared to existing technologies is:

This invention includes an installation board, light strip, light-shielding plate, screws, battery, circuit board, integrated circuit chip, and power interface. By using the battery, circuit board, and USB power interface, the light strip inside the cosmetic box can be recharged and powered, intelligently achieving the purpose of illuminating the light strip. At the same time, the light-shielding plate can softly diffuse the light generated inside the light strip, allowing users to have a clearer view while applying makeup without being obstructed by their line of sight, greatly enhancing the user experience.

### BRIEF DESCRIPTION OF THE DRAWINGS

Drawings are used to provide a further understanding of the present invention and form part of the specification, and are used in conjunction with the embodiments of the present invention to explain the present invention, and do not constitute a limitation on the present invention. In the attached image:

FIG. 1 shows the schematic diagram of the overall appearance structure of the invention;

FIG. 2 shows a schematic diagram of the magnetic suction mechanism structure of the present invention;

FIG. 3 shows a schematic diagram of the light strip structure of the present invention;

FIG. 4 shows the structural diagram of the lighting component of the present invention.

Diagram: 1. Top cover; 2. Bottom cover; 3. Fixing groove; 4. Connecting block; 5. Magnet; 6. Iron piece; 7. Tray; 8. Middle frame; 9. Mounting plate; 10. Light strip; 11. Light shield; 12. Screw; 13. Battery; 14. Circuit board; 15. Integrated circuit chip; 16. Power interface; 17. Mirror; 18. Translucent panel.

### DETAILED DESCRIPTION OF THE EMBODIMENTS

With reference to the drawings in the present invention embodiment, the technical solution in the present invention embodiment is described clearly and completely. It is obvious that the described embodiments are only part of the embodiments of the present invention, not all of them. Based on the embodiments of the present invention, all other embodiments obtained by those skilled in the art in this field without inventive work are within the scope of protection of the present invention.

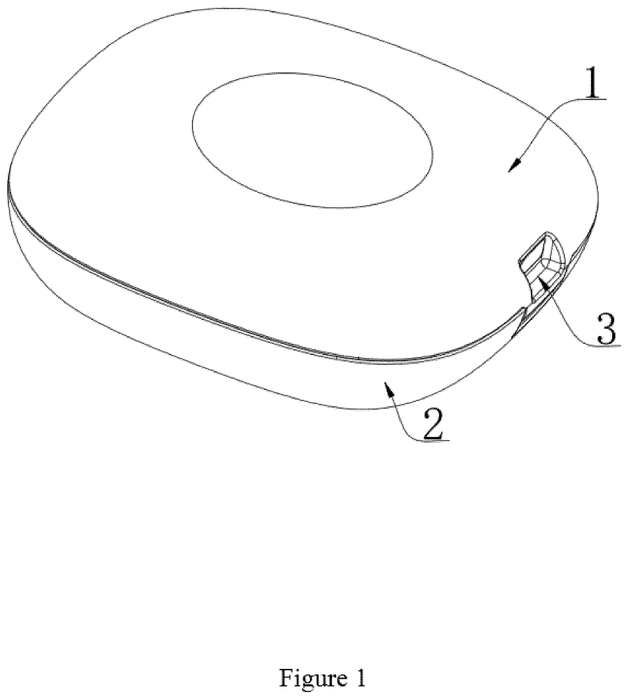

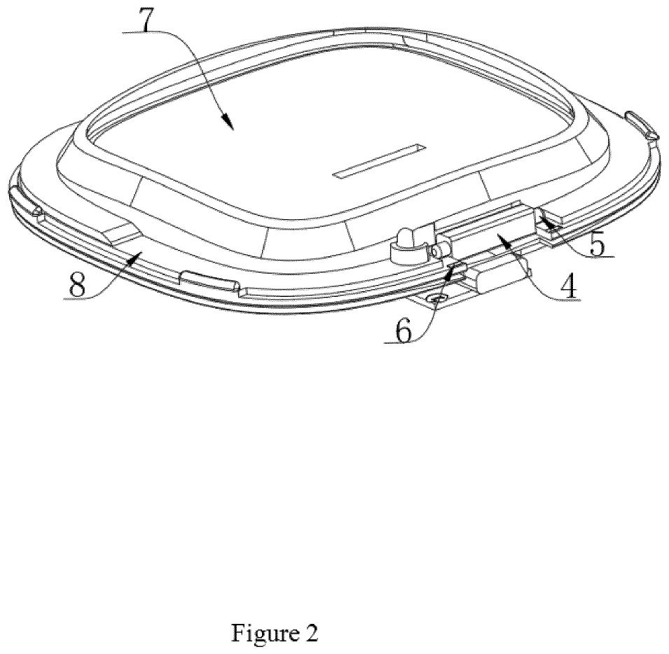

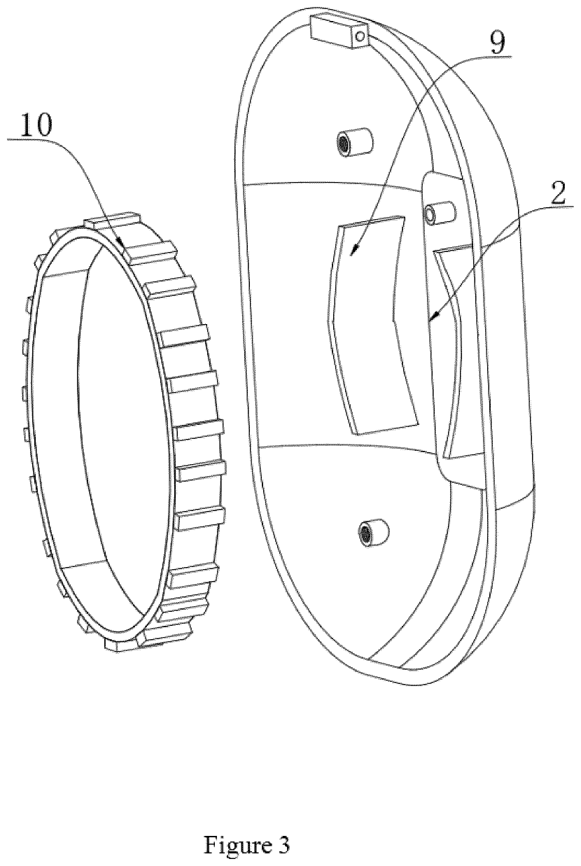

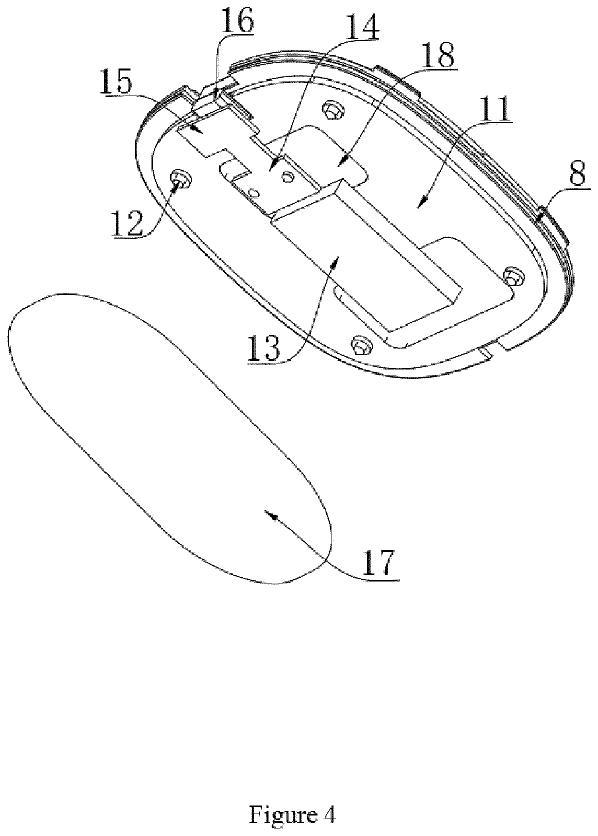

Please refer to FIGS. 1 to 4. The invention provides a technical solution: set up intelligent light-up cosmetic box, including an upper cover 1 and a bottom cover 2. The upper cover 1 is hinged with the bottom cover 2, and a magnetic suction mechanism is provided at the connection between one side of the upper cover 1 and the bottom cover 2. The inner cavity of the upper cover 1 is fixedly connected with a lighting component via bolts.

Lighting component comprising a mounting plate 9, a light strip 10, a light shield 11, screws 12, a battery 13, a circuit board 14, an integrated circuit chip 15, and a power interface 16. The inner cavity of the upper cover 1 is fixedly connected with the mounting plate 9 on both sides. The outer side of the mounting plate 9 is embedded with the light strip 10. The light shield 11 is arranged below the light strip 10, and screws 12 are slidably arranged at the four corners of the light shield 11. The top of the light shield 11 is installed with the battery 13. The output end of the battery 13 is connected to the circuit board 14. One side of the circuit board 14 is fixedly connected to the top of the integrated circuit chip 15. One end of the integrated circuit chip 15 is connected to the power interface 16, which is located at the hinge between the upper cover 1 and the bottom cover 2.

Where: the lighting component also includes the middle frame 8, mirror 17, and light-transmitting sheet 18. The inner wall at the connection of the upper cover 1 and the lower cover 2 is provided with the middle frame 8. The middle frame 8 has a symmetrical detachable structure, and the middle frame 8 is fixed to the light-shielding plate 11 through bolts. The light-shielding plate 11 has light-transmitting sheets 18 opened on both sides of its surface, and one side of the middle frame 8 is embedded with the mirror 17.

Where: the magnetic suction mechanism includes a connecting block 4, a magnet 5, and an iron piece 6. One end of the upper cover 1 is fixedly connected to the connecting block 4 through a bolt, and the two ends of the connecting block 4 are fixedly connected to the magnet 5. One side of the magnet 5 facing each other is provided with an iron piece 6, which is fixedly connected to the bottom cover 2.

Where: there are four iron pieces 6, arranged in a symmetrical structure at one end of the middle frame 8, and the iron pieces 6 are distributed in a groove-like manner.

Where: a tray 7 is installed at the top of one side of the middle frame 8, and the inner cavity of the tray 7 matches the mirror 17.

Where, one end of the upper cover 1 is provided with a fixed groove 3, and the fixed groove 3 is concave downward.

The working principle of the above implementation example is as follows: When in use, the fixed groove 3 can be pressed by fingers to drive the connecting block 4 at the bottom, causing the magnets 5 on both sides to separate from the iron sheet 6 at the bottom. This allows the upper cover 1 and the bottom cover 2 of the cosmetic box to fold open. A middle frame 8 is set between the upper cover 1 and the bottom cover 2, with a mirror 17 embedded on one side of the middle frame 8 for user convenience in makeup application. At this time, the battery 13 inside the cosmetic box can power the light strip 10 at the output end, enabling the light strip 10 to illuminate. The installation plate 9 is designed to wind around the light strip 10 for easy installation. The power interface 16 can be used to charge the battery 13, and the integrated circuit chip 15 can intelligently receive external information and automatically open or close the cosmetic box during the opening process, ensuring that the internal circuit is automatically disconnected when the user closes the upper cover 1 and the bottom cover 2. This design eliminates the need for manual control of the lighting, greatly enhancing the user experience.

Finally, it should be noted that the above is only a preferred embodiment of the invention, and is not intended to limit the invention. Although detailed descriptions of the invention have been provided with reference to the above embodiments, those skilled in the art can still modify the technical solutions described in the above embodiments, or equivalently replace some technical features. Any modifications, equivalents, improvements, etc. made within the spirit and principles of the present invention shall be included within the scope of protection of the present invention.

1. Intelligent lighted cosmetic box, comprising a top cover (1) and a bottom cover (2), characterized in that: the top cover (1) is hinged with the bottom cover (2), a magnetic suction mechanism is provided at the connection of one side of the top cover (1) and the bottom cover (2), and the inner cavity of the top cover (1) is fixedly connected with a lighting component via bolts;
Lighting component, comprising a mounting plate (9), a light strip (10), a light shield (11), screws (12), a battery (13), a circuit board (14), an integrated circuit chip (15), and a power interface (16), The inner sides of the upper cover (1) are fixedly connected with mounting plates (9), and the outer sides of the mounting plates (9) are embedded with light strips (10), A light shield (11) is arranged below the light strip (10), and screws (12) are slidably arranged at the four corner positions of the light shield (11), The top of the light shield (11) is installed with a battery (13), the output end of the battery (13) is connected to the circuit board (14), one side of the circuit board (14) is fixedly connected with the top of the integrated circuit chip (15), one end of the integrated circuit chip (15) is connected to the power interface (16), and the power interface (16) is located at the hinge between the upper cover (1) and the bottom cover (2).

2. Intelligent lighted cosmetic box according to claim 1, characterized in that: the lighting component further comprises a middle frame (8), a mirror (17), and a light-transmitting plate (18), wherein the inner wall of the connection between the upper cover (1) and the lower cover (2) is provided with a middle frame (8), the middle frame (8) is of a symmetrical detachable structure, the middle frame (8) is fixed to the light-shielding plate (11) by bolts, light-transmitting plates (18) are opened on both sides of the surface of the light-shielding plate (11), and a mirror (17) is embedded in one side of the middle frame (8).

3. Intelligent lighted cosmetic box as claimed in claim 1, characterized in that: the magnetic suction mechanism comprises a connecting block (4), a magnet (5), and an iron piece (6), one end of the peripheral side of the upper cover (1) is fixedly connected with a connecting block (4) by a bolt, the two ends of the connecting block (4) are fixedly connected with magnets (5), an iron piece (6) is provided on one side facing the magnet (5) and the iron piece (6) is fixedly connected to the bottom cover (2).

4. Intelligent lighted cosmetic box according to claim 3, characterized in that: the iron pieces (6) are arranged in four, symmetrically distributed at one end of the middle frame (8), and the iron pieces (6) are distributed in a groove-like manner.

5. Intelligent lighted cosmetic box according to claim 2, characterized in that: a tray (7) is installed at the top of one side of the middle frame (8), and the inner cavity of the tray (7) matches the mirror (17).

6. Intelligent lighted cosmetic box according to claim 1, characterized in that: a fixed groove (3) is opened at one end of the upper cover (1), and the fixed groove (3) is concave downward.
